(19) United States
(12) Patent Application Publication
(10) Pub. No.: US 2026/0285642 A1
(43) Pub. Date: Sep. 24, 2026

(54) METHOD FOR UPDATING ELEVATOR SHAFT CONFIGURATION DATA

(71) Applicant: Kone Corporation, Helsinki (FI)

(72) Inventors: Ari JUSSILA, Helsinki (FI); Toni HIRVONEN, Helsinki (FI)

(73) Assignee: Kone Corporation, Helsinki (FI)

(21) Appl. No.: 19/544,423

(22) Filed: Feb. 19, 2026

(30) Foreign Application Priority Data
Mar. 20, 2025 (EP) 25165108.9

(51) Int. Cl. B66B 1/34; G06F 8/65

(52) U.S. Cl. CPC B66B 1/3407; G06F 8/65

(57) ABSTRACT

The invention relates to a method for updating elevator shaft configuration data, whereby either after detecting a loss of integrity of the shaft configuration or on request, the following succession of steps is performed: the elevator is taken out of normal operation, the elevator control system performs an observation run along the elevator shaft and/or manually shaft locations needing an update are input manually, during the observation run run-time data of the shaft configuration are detected and compared to the existing shaft configuration data to obtain any locations of data discrepancies, a subsequent low-speed partial configuration run is performed only in the zone(s) of locations of data discrepancies and/or of manually input locations, new configuration data obtained in the low-speed partial configuration run are combined with the existing configuration data.

### CROSS-REFERENCE TO RELATED APPLICATION

This application claims priority to European Patent Application No. EP25165108.9 filed on Mar. 20, 2025, the entire contents of which are incorporated herein by reference.

### TECHNOLOGICAL BACKGROUND

The present invention relates to the updating of shaft configuration data in an elevator control system. During commissioning, a setup run with an elevator car is carried out to acquire setup data of the elevator shaft configuration. Such configuration data may comprise floor positions and door sides, for example, as required for operation of the elevator control system. Floor positions may be marked with stationary position targets, e.g. magnets, located in an elevator shaft. These targets can be detected by a reader device attached to an elevator car. Commonly, the setup run is a low speed run wherein the elevator car travels with low speed the full length of the elevator shaft.

Shaft configuration data can be used for several purposes, such as for movement control of an elevator, for absolute positioning system of an elevator car and/or for monitoring rope slipping in an elevator, for example. Therefore, the integrity and accuracy of the data is important.

In case of loss of integrity of the shaft configuration data which may be detected during normal elevator operation, a new setup run is carried out. This loss of integrity may happen for example if a position target indicating landing floor position, regularly a floor magnet, is broken. Further, new configuration data has to be added in case new position targets are added to the elevator system during the construction of a building, particularly in Jump-lift systems. In this case a new setup run is performed at a low speed over the whole shaft length. This can be time consuming, especially in higher buildings with long elevator travel distances.

### SUMMARY OF THE INVENTION

The objective of the present invention is to solve the above-mentioned problems and to provide a fast and efficient method to renew, restore or update shaft configuration data in an elevator control system. This object is solved with a method as specified in claim 1. Preferred embodiments of the invention are subject matter of the dependent claims. Preferred embodiments of the invention are also described in the following description and drawings.

The base idea of the invention is the provision of partial setup run, which is carried out only in the locations of changes in the shaft configuration changes. And only those changes in the shaft configuration data are updated to the existing configuration data, instead of performing a new, full-length setup run with a low speed, which is expensive and time consuming.

If during normal elevator operation a loss of integrity of the shaft configuration data is detected, e.g. because of a broken position target, the elevator is taken out of operation. Another situation for the necessity of an update of the shaft configuration data occurs if changes to the elevator shaft have been made which are now to be added to the shaft configuration data, for example after the change of shaft components or in a Jump-lift situation. In this case an update of the shaft configuration data is initiated on request. Also, in this case the elevator is taken out of normal operation.

If the change of shaft configuration data has been detected during elevator operation the elevator control system first performs an observation run, preferably along the whole length of the elevator shaft. Preferably this observation run is performed with a comparably high speed, preferably with a speed above nominal speed, particularly with buffer impact speed. This has the advantage that the observation run can be performed in a comparably short time which reduces the total elevator-off time. During the observation run run-time data of the shaft configuration are detected and the detected run-time data are compared to the existing shaft configuration data to obtain any data discrepancies, with the aim to determine the locations of the data discrepancies.

Alternatively, in case the update of the shaft configuration data is initiated on request, the locations of the shaft changes are input manually.

Now, in both cases a subsequent low-speed partial configuration run is performed with a speed below elevator's nominal speed. In contrast to prior art the partial configuration run is performed only in the zone(s) where locations of data discrepancies have been found and/or in manually input locations needing an update. This has the advantage that the low-speed configuration run has only to be performed in a comparably small zone which leads to an essential reduction of elevator-off time. This particularly holds true for high-rise lifts having shafts of 100 meters or higher. If the zone requiring an update of shaft configuration data is only 5 meters, the time saving can add up from several minutes to half an hour.

Now, the new configuration data obtained in the low-speed partial configuration run, e.g. new position target IDs and exact locations, are combined with the existing shaft configuration data to complete the shaft configuration data update. This inventive method thus provides a very efficient and time-saving option to update shaft configuration data in case of component failures as well as on request in case of changes performed on the shaft configuration, e.g. in case of changes of shaft components or in Jump-lift situations after adding new floors above the existing shaft.

As mentioned before, the observation run is preferably performed along the full length of the elevator shaft which enables the elevator control system to gather all new or changed shaft configuration along the elevator shaft.

Preferably, the observation run is performed with a comparably high velocity, preferably with a velocity above nominal speed, particularly with buffer impact speed which is usually about 110 to 120% of nominal speed. A typical area for the nominal speed of mid-sized elevators is about 2.5 m/s, preferably 2 to 8 m/s. So, the observation run is performed with a speed clearly above the low-speed partial configuration run so that the check-up of the elevator shaft for new or changed configuration data is performed much faster than in prior art wherein the low-speed configuration run went over the whole shaft length. In the low-speed partial configuration run the elevator control system is able to provide the locations of changed shaft equipment with a high accuracy as well as the ID thereof. Accordingly, accurate new shaft configuration data is obtained very fast and reliable.

In case of high-rise elevators, the observation run can be performed with a velocity above nominal speed whereas in the areas of the upper and lower shaft ends, the velocity can be reduced to buffer impact speed, which even may be below nominal speed. In high-rise elevators which have shaft lengths for example above 100 m, the nominal speed is often very high for example 8 m/s and in the shaft ends, the elevator speed is automatically reduced to buffer impact speed which is essentially lower.

The low-speed partial configuration run is preferably performed in the common maintenance speed range which is about 0.1 to 0.5 m/s. As it has already been mentioned, the use of low speed for the configuration run has the advantage that the locations of the changed or new configuration data are determined with a high accuracy which leads to a better elevator performance in subsequent normal operation. Accordingly, with exactly determined and configured floor position targets it is possible to provide exact stop position of the elevator car levelling exactly with the adjacent floors.

In a preferred embodiment of the invention, after the completion of the shaft configuration data update, the elevator is returned into normal operation so that it is open for normal use again. This reduces the off times of the elevator in connection with an update of the shaft configuration data to a minimum.

Preferably, the inventive method is performed after an addition or replacement of position targets which are commonly embodied as floor magnets. If, for example, a floor magnet is broken, this situation is detected by the elevator control system during normal operation as a discrepancy of the actually sensed data with the stored elevator shaft configuration data. Detecting this discrepancy, the elevator is then taken out of normal operation and the observation run is performed whereby this broken floor magnet position is detected. Now, the low-speed configuration run is after replacement of the broken floor magnet only performed in the area of the replaced floor magnet, for example from one floor higher to one floor lower with respect to the position where the floor magnet was broken. This leads to the detection of the location of the changed floor target with a high precision.

It is to be remarked that preferably the observation run is always started from the upper or lower end of the elevator shaft. This means that before the start of the observation run, the elevator is driven to the uppermost or lowermost moving position in the shaft, particularly using of a travel minimization strategy from the actual position of the elevator car. The start of the observation run from one shaft end has the advantage that the observation run is one continuous run from the upper to the lower or from the lower to the upper end which is fast and provides definite location data for new or changed configuration data.

Preferably, each position target comprises at least one, preferably two, unique IDs which identify the position target in the system. With the exchange of a position target, for example after a position target is broken, a new position target is mounted which has a different ID from that of the previous broken position target. During the configuration run, this new ID is stored together with the exact position of the new position target in the new configuration data set during the low-speed partial configuration run.

In a preferred embodiment of the invention, the elevator control system detects during the observation run at least one of following parameters:
types and positions of elevator components,
RFID tags of elevator components, and/or
unique IDs of elevator components.

This data enable the elevator control system to exactly identify the position and type of each elevator shaft component.

Preferably, the inventive method is used in Jump lifts which are used in elevator buildings during building construction where floors are added on top of the buildings and the elevator is used for the already existing floors as a transport medium in the building site. After a couple of new floors, the lift is then extended into the new floors which have been freshly built on top of the building. In this case, the elevator is preferably driven to the floor below the previous top floor and then the partial low-speed configuration run is performed from thereon upwards so that only newly added floors above the previous top floors are detected and added to the shaft configuration data. Thus, the inventive method offers a fast and reliable possibility to add new floor data in a Jump lift situation.

As it has been mentioned above, the zone which is used for the low-speed partial configuration run is preferably one floor below and one floor above the location of a data discrepancy or of a changed shaft component location.

The invention also refers to an elevator, which is able to perform the method as it has been described above. This elevator is configured to perform an observation run along the elevator shaft using a speed above the elevator's nominal speed and to perform a low-speed partial configuration run with a speed below elevator's nominal speed only in defined shaft zones. For the features and advantages of such an elevator, it is referred to the above description of the inventive method.

It is obvious for the skilled person that the above embodiments of the invention can be combined arbitrarily.

Following terms are used as synonyms: floor target—position target—floor magnet—floor position indicator; sensing device—reader device;

The invention is now described by an example with respect to the enclosed schematic drawing. Therein,

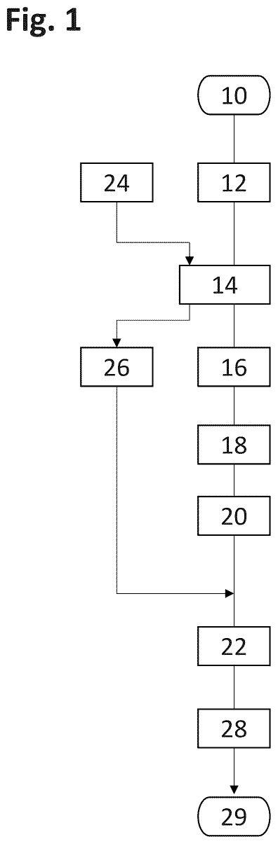

FIG. 1 shows a flow diagram of the inventive method, and

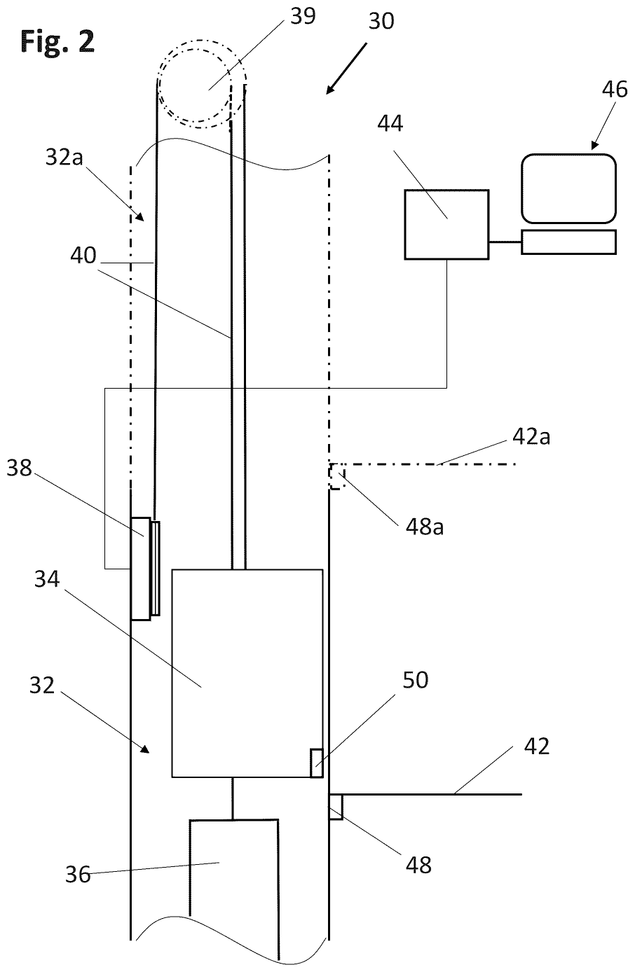

FIG. 2 is a schematic diagram of a Jump lift in a situation where a new floor is added above an existing elevator shaft.

The inventive method starts at start point 10 and proceeds to the detection of a shaft configuration discrepancy during normal elevator operation in step 12. Thereafter, the elevator is taken out of normal operation in step 14. Subsequently in step 16, an observation run is initiated, preferably with a speed above nominal speed of the elevator. During the observation run, run-time data of the shaft components are gathered in step 18, whereafter in step 20, the detected runtime data of the observation run are compared with the existing shaft configuration data to obtain any data discrepancies and the locations thereof. Now a low-speed partial configuration run is performed in step 22, preferably with a speed below elevator's nominal speed and only in the zones where the locations of data discrepancies have been found in the observation run, whereby the zones preferably extend one floor above and one floor below the location of a data discrepancy.

As an alternative to the detection of a data discrepancy in normal elevator operation according to step 12, a location of a changed elevator component can be manually input in step 24 after which in step 14, the elevator is taken out of normal operation in the same way as when a data discrepancy has been found in normal operation according to step 12. In this case, the method branches to step 26 where the location of the changed elevator shaft component is manually input into the system instead of performing an observation run. The method then proceeds further to step 22 where the low-speed partial configuration run is performed only in the zone of the location of the changed shaft component data which has been input in step 26.

In both cases the new configuration data obtained in the low-speed partial configuration run are combined in step 28 with existing configuration data and the shaft configuration data update is terminated in end step 29 where the elevator is put back into normal operation.

The manual input alternative of this inventive method according to steps 24 and 26 can be provided in a case of a repair or change of an elevator shaft component in an existing elevator shaft, for example a changed floor magnet, or in case of a Jump lift elevator.

FIG. 2 shows schematically a Jump lift elevator situation. A Jump lift is used during a building stage of a building. It grows in height together with the height growth of a high rise building during its building stage. In Jump lift on the existing elevator shaft is continuously extended on its top. In FIG. 2 the Jump lift 30 comprises an old elevator shaft 32, in which an elevator car 34 and a counterweight 36 are running driven via an elevator drive machine 38 via elevator ropes 40. The ropes run around upper diverting pulleys 39 in the top of the shaft.

The drive machine 38 is controlled by an elevator control system 44 which is connected to an IO-device 46 comprising a keyboard and a display. In the area of the floors 42 of the old elevator shaft 32, floor magnets 48 are positioned as floor position indicators. These floor magnets 48 are sensed by a sensing device 50 located in connection with the elevator car 34.

In the new elevator shaft part 32a on top of the old shaft 32 a new floor 42a has to be added on top of the uppermost existing floor 42 of the old elevator shaft 32. In connection with the new floor 42a a floor magnet 48a is provided which has to be added to the existing shaft configuration data in the elevator control system 44.

After completion of the new elevator shaft part 32a above the old shaft part 32 and the mounting of the new floor magnets 48a in the new floors 42a, a manual input is performed via the keyboard of the input/output device 46 to initiate the elevator control system 44 to add the new floor magnet 48a of the new shaft part 32a into the shaft configuration data according to step 24 of the method of FIG. 1. Now the elevator 30 is removed from normal operation according to step 14.

With his input, the service technician inputs according to step 26 to the elevator control system 44 the location of the new or changed shaft configuration. In the present case specifies the location of change as a new floor magnet 48a above the old shaft part 32. After the elevator control system 44 has learned via step 26 the locations of the added elevator shaft components, the elevator control system performs a low-speed partial configuration run according to step 22 only in the new shaft part 32a to determine the position of the new floor magnet 48a relating to the newly added elevator floor 42a. For example, elevator car may be run to the floor below the old top floor, and then the car is driven up from there with the low-speed partial configuration run, so that the new floor magnets 48a in the new floors 42a built above the previous top floor are recorded. After detection of the ID and exact location of the new floor magnet 48a during this low-speed partial configuration run via the sensing device 50 in the elevator car 34, this new floor magnet 48a is added in step 28 to the existing shaft configuration data in the elevator control system 44 so that from now on the elevator system 30 is able to serve also the new floors 42a in the new shaft part 32a.

It is apparent for the skilled person that the described embodiments are not limiting for the scope of the protection of the present invention which can be varied within the scope of the appended patent claims.

### LIST OF REFERENCE NUMBERS

10 starting point of the inventive method
12 detection of a shaft configuration discrepancy
14 taking the elevator out of operation
16 an observation run is initiated, preferably with a speed above nominal speed of the elevator
18 during the observation run run-time data of the shaft configuration are detected
20 the detected runtime data of the observation run are compared with the existing shaft configuration data to obtain any data discrepancies and the locations thereof
22 a low-speed partial configuration run is performed
24 in an alternative changes in the shaft configuration are manually input
26 the location of a changed elevator component is manually input befor running the low-speed partial configuration run
28 new configuration data obtained in the low-speed partial configuration run are combined with existing configuration data
29 the elevator is put back to normal operation
30 jump lift (traction sheave elevator)
32 old elevator shaft
32a new shaft part above the old elevator shaft
34 elevator car
36 counterweight
38 elevator drive machine
39 upper diverting pulleys
40 elevator ropes
42 floor of the elevator shaft
42a new floor of the elevator shaft
44 elevator control system
46 input/output (I/O)-device
48 floor magnets as floor position indicators
48a new floor magnets in the new floors of the jump lift
50 sensing device 50 located in connection with the elevator car

1. Method for updating elevator shaft configuration data in an elevator control system, whereby either after detecting a loss of integrity of the shaft configuration during elevator operation or on request, e.g. after the change of elevator shaft components, the following succession of steps is performed:
the elevator is taken out of normal operation,
the elevator control system performs an observation run along the elevator shaft and/or manually shaft locations needing an update are input manually,
during the observation run run-time data of the shaft configuration are detected,
the detected run-time data are compared to the existing shaft configuration data to obtain any data discrepancies, whereby the locations of the data discrepancies are determined,
a subsequent low-speed partial configuration run is performed with a speed below elevator's nominal speed only in the zone(s) of locations of data discrepancies and/or of manually inputted locations needing an update,
new configuration data obtained in the low-speed partial configuration run are combined with the existing configuration data to complete the shaft configuration data update.

2. Method according to claim 1, according to which the observation run is performed along the full length of elevator shaft.

3. Method according to claim 1, according to which the observation run is performed using buffer impact speed, preferably about 2-5 m/s.

4. Method according to claim 1, wherein with the completion of the shaft configuration data update the elevator is put back to normal operation.

5. Method according to claim 1, wherein the observation run is performed with a speed above the low-speed partial configuration run, preferably above elevator's nominal speed, particularly with buffer impact speed.

6. Method according to claim 1, wherein the low-speed partial configuration run is performed in maintenance speed, preferably 0.1-0.5 m/s.

7. Method according to claim 1, wherein the method is performed after an addition or replacement of position targets, particularly floor magnets.

8. Method according to claim 1, wherein before the start of the observation run, the elevator is driven to the uppermost or lowermost moving position in the shaft.

9. Method according to claim 1, wherein each position target comprises at least one, preferably two unique IDs.

10. Method according to claim 1, wherein the elevator control system detects during the observation run at least one of following parameters:
types and positions of elevator components
RFID tags of elevator components,
unique IDs of elevator components.

11. Method according to claim 1, wherein in case of an extension in Jump lifts the elevator is driven to the floor below the previous top floor and then the partial configuration run is performed from there upwards so that only newly added floors above the previous top floor are determined.

12. Method according to claim 1, wherein the zone of a location of data discrepancy extends one floor below and one floor above the location of the data discrepancy.

13. Elevator, which is configured to perform the method according to claim 1, and which is able to perform an observation run along the elevator shaft and to perform a low-speed partial configuration run only in defined shaft zones, whereby the speed of the observation run is higher than the speed of the partial configuration run.

14. Elevator according to claim 13, being able to perform the observation run with a speed above elevator's nominal speed, preferably in the range of 2 to 8 m/s.

15. Elevator according to claim 13, being able to perform the partial configuration run with a speed below elevator's nominal speed, preferably in the range of 0.1 to 0.5 m/s.
